(19) United States
(12) Patent Application Publication
(10) Pub. No.: US 2007/0010293 A1
(43) Pub. Date: Jan. 11, 2007

(54) Phone connected to a personal computer

(75) Inventor: Chao-Han Chang, Taipei (TW)

Correspondence Address: BACON & THOMAS, PLLC, 625 SLATERS LANE, FOURTH FLOOR, ALEXANDRIA, VA, 22314, US

(73) Assignee: PCHOME ONLINE INC., Taipei (TW)

(21) Appl. No.: 11/415,253

(22) Filed: May 2, 2006

(30) Foreign Application Priority Data
Jul. 8, 2005 (TW) 094211676

(51) Int. Cl. H04M 1/00

(52) U.S. Cl. 455/569.1; 455/556.1

(57) ABSTRACT

An internet phone with a speaker plug of the present invention comprises: a mini-speaker, a microphone, a microphone plug, an audio plug, a speaker plug, a wire and a switch, wherein the microphone is electrically connected to the microphone plug, the speaker plug is connected to an external speaker. The switch is used for internet phone providing two states, the first state being able to electrically connect a mini-speaker with the audio plug but not with the speaker plug, the second state being able to electrically connect the audio plug with the speaker plug but not with the mini-speaker.

### BACKGROUND OF THE INVENTION

1. Field of the Invention

The present invention relates to an internet phone, and, more particularly, to an internet phone connected to a personal computer.

2. Description of the Related Art

With the growth of internet technology, internet phones have been developed, which include VOIP (Voice over Internet Protocol) and Skype. Compared to traditional phones, internet telephone usage charges are much lower, or even free. Because in the last few years the quality of internet phone technology and devices has continuously improved, internet telephones are becoming more and more popular. The prior art internet phone includes a mini-speaker, a microphone, an audio plug and a microphone plug. When a user is using the internet phone, he or she needs to respectively connect the audio plug and the microphone plug into an audio card of a computer. When a call comes in, the mini-speaker is used for receiving the caller's voice, but if the user is listening to music at the time, he or she has to unplug the speaker plug and replace it with the audio plug. Therefore, the audio plug and the speaker plug are often swapped, which is very inconvenient for the user and may cause damage to the audio plug and the microphone plug.

Therefore, it is desirable to provide an internet phone capable of connecting to a computer that mitigates and/or obviates the aforementioned problems.

### SUMMARY OF THE INVENTION

The main objective of the present invention is to provide an internet phone, and when a user uses the internet phone he or she can choose to use a mini-speaker to receive the calling voice from the internet phone or choose a speaker to directly play the calling voice.

In order to achieve the above-mentioned objective, an internet phone with a speaker plug of the present invention comprises: a mini-speaker, a microphone, a microphone plug, an audio plug, a speaker plug, a wire and a switch, wherein the microphone is electrically connected to the microphone plug, the speaker plug is connected to an external speaker. The switch is used for internet phone providing two states, the first state being able to electrically connect a mini-speaker with the audio plug but not with the speaker plug, the second state being able to electrically connect the audio plug with the speaker plug but not with the mini-speaker. The present invention can enable the user to choose the proper state to receive the calling voice from the internet telephone.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of an internet phone with a speaker plug according to a first embodiment of the present invention.

FIG. 2 is a functional block drawing of the present invention.

FIG. 3 is a schematic drawing of an internet phone with a speaker plug according to a second embodiment of the present invention.

### DETAILED DESCRIPTION OF THE PREFERRED EMBODIMENT

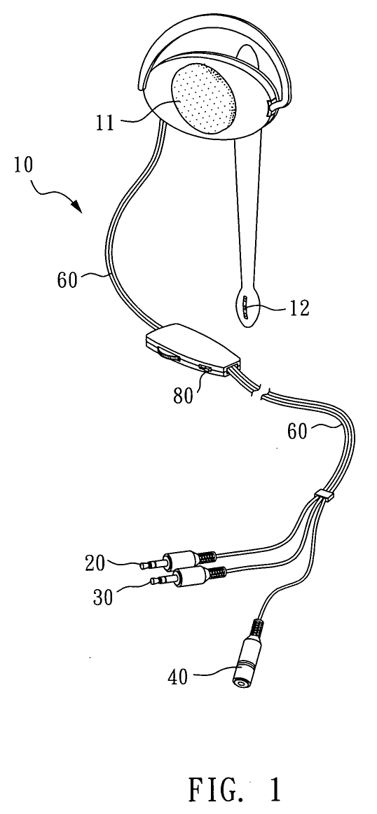

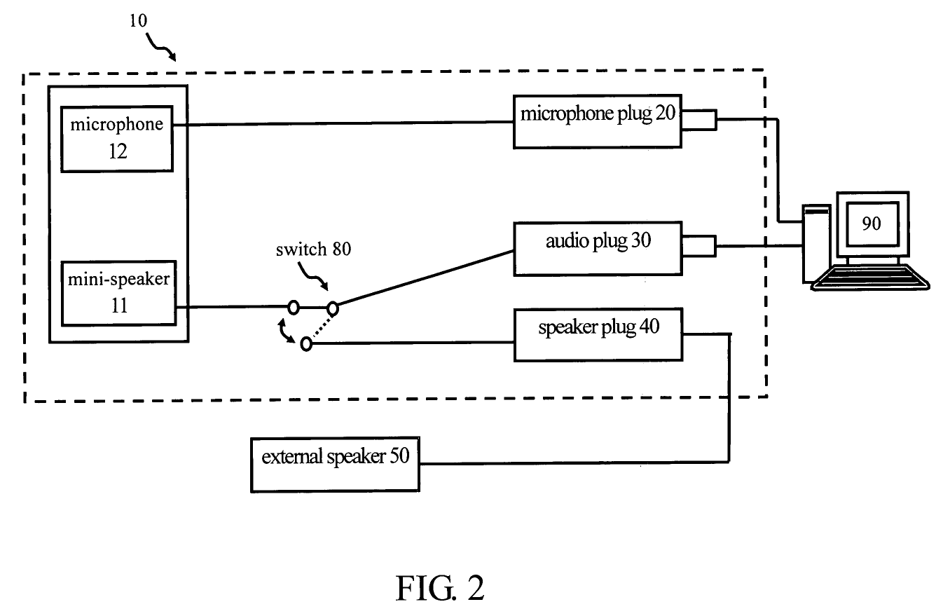

Please refer to FIG. 1 and FIG. 2. FIG. 1 is a schematic drawing of an internet phone with a speaker plug according to a first embodiment of the present invention. FIG. 2 is a functional block drawing of the present invention. In the first embodiment, an internet phone 10 is ear-hanging type and comprises: a mini-speaker 11 (e.g. eraphone), a microphone 12, a microphone plug 20, an audio plug 30, a speaker plug 40, at least one wire 60 and a switch 80. The microphone 12 and the audio plug 30 are electrically connected to each other, and the audio plug 30 can be connected into an audio card of a computer 90. The speaker plug 40 is can be connected to a external speaker 50. Three wires 60 are separately connected to the microphone plug 20, the audio plug 30 and the speaker plug 40.

The switch 80 is used to provide two states for the internet phone 10: the first state is able to electrically connect the mini-speaker 11 to the audio plug 30 but not to the speaker plug 40; the second state is able to electrically connect the audio plug 30 to the speaker plug 40 but not to the mini-speaker 11. In the first state, audio from the internet phone 10 is sent to the mini-speaker 11 to maintain privacy. In the second state, the speaker plug 40 can be connected to the speaker 50, and the speaker 50 plays the call audio. Therefore, the user can use the switch 80 to choose how to listen to the audio from the internet phone. Moreover, the internet phone 10 with the speaker plug does not have to have the microphone 12, and instead may simply be used only with the mini-speaker 11 and the switch 80.

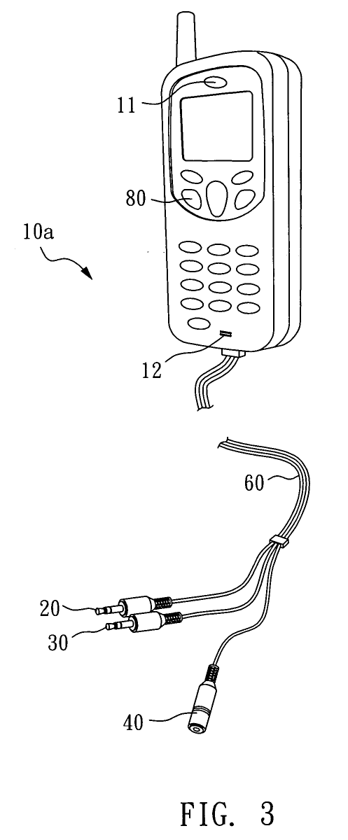

Please refer to FIG. 2 and FIG. 3. FIG. 3 is a schematic drawing of an internet phone with a speaker plug according to a second embodiment of the present invention. A main difference between the second embodiment and the first embodiment is that the internet phone 10a is a handheld type; the mini-speaker 11 and the microphone 12 can be disposed on the handheld type internet phone 10a, and the switch 80 can also be disposed on the internet phone 10a.

Although the present invention has been explained in relation to its preferred embodiment, it is to be understood that many other possible modifications and variations can be made without departing from the spirit and scope of the invention as hereinafter claimed.

What is claimed is:

1. An internet phone with a speaker plug comprising:
a mini-speaker;
an audio plug;
a microphone;
a microphone plug electrically connected to the microphone;
a speaker plug for connecting to an external speaker; and
a switch providing two states, the first state capable of electrically connecting the mini-speaker with the audio plug but not with the speaker plug, the second state capable of electrically connecting the audio plug with the speaker plug but not with the mini-speaker.

2. The internet phone with a speaker plug as claimed in claim 1, wherein the internet phone with a speaker plug is ear-hanging type.

3. The internet phone with a speaker plug as claimed in claim 1, wherein the internet phone with a speaker plug is handheld type.

4. A mini-speaker with a switch device comprising:
a mini-speaker;
an audio plug;
a speaker plug being a plug for connecting to an external speaker; and
a switch providing two states, the first state being able to electrically connect the mini-speaker with the audio plug but not with the speaker plug, the second state being able to electrically connect the audio plug with the speaker plug but not with the mini-speaker.

5. The mini-speaker with a switch device as claimed in claim 4, wherein the mini-speaker with a switch device is ear-hanging type.

6. The mini-speaker with a switch device as claimed in claim 4, wherein the mini-speaker with a switch device is handheld type.
